(19) United States
(12) Patent Application Publication
(10) Pub. No.: US 2025/0214496 A1
(43) Pub. Date: Jul. 3, 2025

(54) SEAT FRAME FOR VEHICLE

(71) Applicant: Nissan Motor Co., Ltd., Yokohama-shi, Kanagawa (JP)

(72) Inventor: Tetsuya KAWAJIRI, Kanagawa (JP)

(21) Appl. No.: 18/879,273

(22) PCT Filed: Jul. 11, 2022
(86) PCT No.: PCT/JP2022/027266

§ 371 Date: Dec. 27, 2024

(51) Int. Cl. B60N 2/70; B60K 1/04; B60N 2/72

(52) U.S. Cl. CPC B60N 2/7094; B60K 1/04; B60N 2/72; B60K 2001/0422

(57) ABSTRACT

A seat frame for a vehicle includes a pair of side arms of a bottom frame that supports buttocks and thighs of an occupant from below, and a pair of cross members that connect front sections and rear sections of the side arms, respectively. At least two S-springs are stretched between the two cross members or the two side arms, and a retention member is attached between the S-springs. A tensible wire is attached between one of the two cross member or one of the two side arms to which the S-spring is attached and the retention member.

### TECHNICAL FIELD

The present invention relates to a seat frame for a vehicle.

### BACKGROUND ART

A seat for a vehicle is generally configured by covering a foam resin cushion material over a metal seat frame. The cushion material is further covered with a seat fabric. The seat frame mainly includes a bottom frame that supports an occupant's buttocks and thighs from below and a back frame that supports the occupant's upper body from behind. The present invention relates particularly to a structure of a bottom frame.

A Patent Literature 1 discloses a typical structure of a bottom frame. The bottom frame disclosed in the Patent Literature 1 includes a pair of side arms that constitute both sides, a front member that connects front sections of the pair of side arms, and a rear member that connects rear sections of the pair of side arms. Plural S-springs (serpentine springs) are stretched between the pair of side arms (FIG. 2 in the Patent Literature 1). A front pan may be provided above the front member (FIG. 11A in the Patent Literature 1). The plural S-springs may be stretched between the front member and the rear member (FIG. 11A in the Patent Literature 1). In general, the bottom frame is slidably mounted on a pair of seat rails (FIG. 11A of the Patent Literature 1).

### CITATION LIST

### Patent Literature

Patent Literature 1: Japanese Patent Application Publication No. 2019-172237

### SUMMARY OF INVENTION

### Problem to be Solved

The occupant's buttocks and thighs are supported from below by the S-springs and the cushioning material. Generally, the lower the stiffness of the S-springs and the cushioning material is made, the more improved the ride comfort is. The bottom unit of the seat supports occupant's buttocks and thighs from below over a wide area. However, the occupant may kneel on one knee on the bottom unit to pick up a luggage on the seat on the other side. In such a case, the occupant's weight acts on a narrow area and thus a downward displacement of the seat surface becomes larger than a downward displacement when the occupant seats thereon. That is, the downward displacement of the S-springs becomes excessive, and thereby it becomes difficult to pick up the luggage.

An object of the present invention is to provide a seat frame for a vehicle that can improve ride comfort while restricting an excessive downward displacement of its S-springs.

### Solution to Problem

An aspect of the present invention provides a seat frame for a vehicle that includes a pair of side arms of a bottom frame, and a pair of cross members that connect front sections and rear sections of the side arms, respectively. At least two S-springs are stretched between the two cross members (or the two side arms), and a retention member is attached between the S-springs. A tensible wire is suspended between one of the two cross member (or one of the two side arms) to which the S-spring is attached and the retention member.

### Advantageous Effects

According to the aspect, it is possible to restrict an excessive downward displacement of the S-springs by the tensible wire while improving ride comfort.

### BRIEF DESCRIPTION OF DRAWINGS

FIG. 1 is a perspective view of a seat frame for a vehicle according to an embodiment.

FIG. 2 is an exploded perspective view of an excessive downward displacement restriction mechanism for S-springs of a bottom frame in the above frame structure.

FIG. 3 is a (partially cross-sectioned) side view of the excessive downward displacement restriction mechanism.

### DESCRIPTION OF EMBODIMENTS

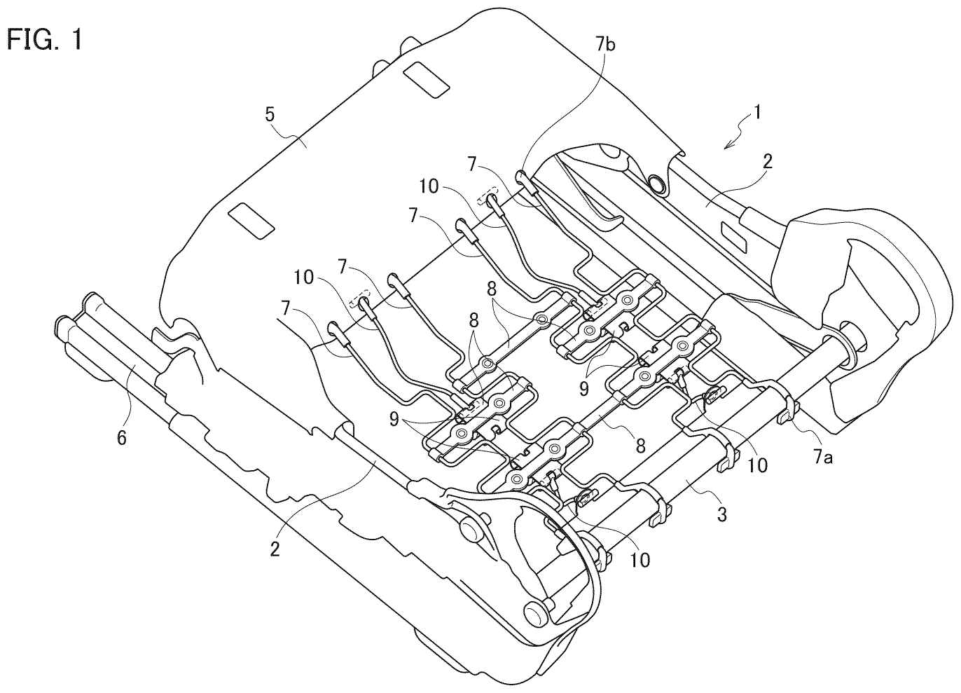

Hereinafter, an embodiment of a seat frame for a vehicle will be described with reference to the drawings. The seat frame of the present embodiment is a seat frame for a front seat of an electrified vehicle such as a battery electric vehicle (BEV) or a hybrid electric vehicle (HEV). The seat frame includes a bottom frame 1 shown in FIG. 1 that supports occupant's buttocks and thighs from below and a back frame that supports an occupant's upper body from behind. Since features of the present embodiment are contained in the bottom frame 1, the back frame is not shown in FIG. 1. The bottom frame 1 is covered by a foam resin cushion material, and the cushion material is further covered with a seat fabric. However, neither the cushioning material nor the seat fabric is shown in FIG. 1.

As shown in FIG. 1, the bottom frame 1 includes a pair of side arms 2 made of steel. The side arms 2 extend forward from a reclining fulcrum between the bottom frame 1 and the back frame. A rear member 3 that connects rear sections of the side arms 2 is provided at a position of the reclining fulcrum. A front member 4 (see FIG. 3) that connects front sections of the side arms 2 is also provided. Although not shown in the drawings, a further front member similar to the front member 4 shown in FIG. 3 is also provided in front of the front member 4. The rear member 3 and the front members 4 in the present embodiment are round pipes made of steel.

The front members 4 and the rear member 3 are cross members that connect the front sections and the rear sections of the two side arms 2, respectively. A front pan 5 that supports the occupant's thigh from below is provide above the two front members 4. The front pan 5 is attached to the bottom frame 1 so as to connect the front sections of the side arms 2, and the front pan 5 is also a kind of “cross member connecting the front sections of the side arms 2”. Motors or the like (not shown in the drawings) for adjusting a sliding position of the seat, an angle of the bottom frame 1, and a reclining angle of the seat back are disposed below the front pan 5.

The four S-springs (serpentine springs) 7 are stretched between the rear member 3 and the front pan 5 (i.e., between the two cross members). In the present embodiment, the S-springs 7 are made of spring steel and are stretched in a longitudinal direction of the vehicle. The S-springs 7 support the seated occupant's buttocks from below. The S-springs 7 are made convex downwardly due to a mass of the occupant to improve seating comfort. The S-springs 7 also reduce vibrations transmitted from the vehicle to the occupant through the seat.

Each of the S-springs 7 includes a T-shaped hook 7a at its rear end and a J-shaped hook 7b at its front end. The T-shaped hook 7a is formed at an end of the spring steel that is curved to fit the round cross-sectional shape of the rear member 3. The T-shaped hook 7a is hooked from above onto the rear member 3 so as to allow the rear end of the S-spring 7 to swing vertically with respect to the rear member 3. The J-shaped hook 7b is loosely hooked into a hole formed at a rear edge of the front pan 5. Thus, the front end of the S-spring 7 is also vertically swingable with respect to the front pan 5 (as a kind of the cross member). When a load acts on the S-spring 7 from above, the middle of the S-spring 7 flexes downward, but, due to swinging of both ends of the S-spring 7, the flexure of the S-spring 7 is not inhibited and any unnecessary stress doesn't acts on the ends of the S-spring 7.

Retention members 8 are attached between the two adjacent S-springs 7. Both ends of each retention member 8 are formed to have cylindrical portions, and the both ends are respectively attached to the S-springs 7 so that the S-springs 7 respectively pass through the cylindrical portions. The retention members 8 prevent the adjacent S-springs 7 from deforming such that they are separated from each other in the lateral direction of the vehicle when a load is applied from above. Since the S-springs 7 will not be able to receive the load properly due to occurrence of such a separation, such a separation is prevented by the retention members 8. The retention members 8 in the present embodiment are made of plastic and can flex appropriately. This improves seating comfort. In the present embodiment, the two rear retention members 8 are also connected to each other (integrally molded). The retention members 8 may be formed of a metal such as spring steel similar to the S-springs 7. In this case, the metal retention members 8 can be attached to the S-springs 7 with metal clips or the like.

As mentioned above, (although too low stiffness of the S-springs 7 will not adequately support the occupant,) the low stiffness of the S-springs 7 can improve the ride comfort. However, the excessive downward displacement of the S-springs 7 in the case of the above-mentioned load concentration made by one knee should be restricted. For this reason, an excessive downward displacement restriction mechanism is provided in the present embodiment. The excessive downward displacement restriction mechanism is realized by tensible wires 10 suspended between the retention member 8 and the rear member 3 or the front pan 5 (as the cross member).

The tensible wires 10 can also be referred to as tensible strings. In the present embodiment, the four tensible wires 10 are provided. The first one of them is attached between the first retention member 8, which is attached between the rear sections of the two adjacent S-springs 7 on the right side, and the rear member 3. The second one of them is attached between the second retention member 8, which is attached between the rear sections of the two adjacent S-springs 7 on the left side, and the rear member 3. The third one of them is attached between the third retention member 8, which is attached between the center sections of the two adjacent S-springs 7 on the right side, and the front pan 5. The fourth one of them is attached between the fourth retention member 8, which is attached between the center sections of the two adjacent S-springs 7 on the left side, and the front pan 5.

Each of the retention members 8 includes a metal holder 9 to which the end of the tensible wire 10 is swingably attached. Each of the both ends of the holder 9 is made two-pronged and curled. The holder 9 is inserted into the retention member 8 when the plastic retention member 8 is molded. The ends of the tensible wires 10 may be attached directly to the retention member 8 without providing a member like the holder 9.

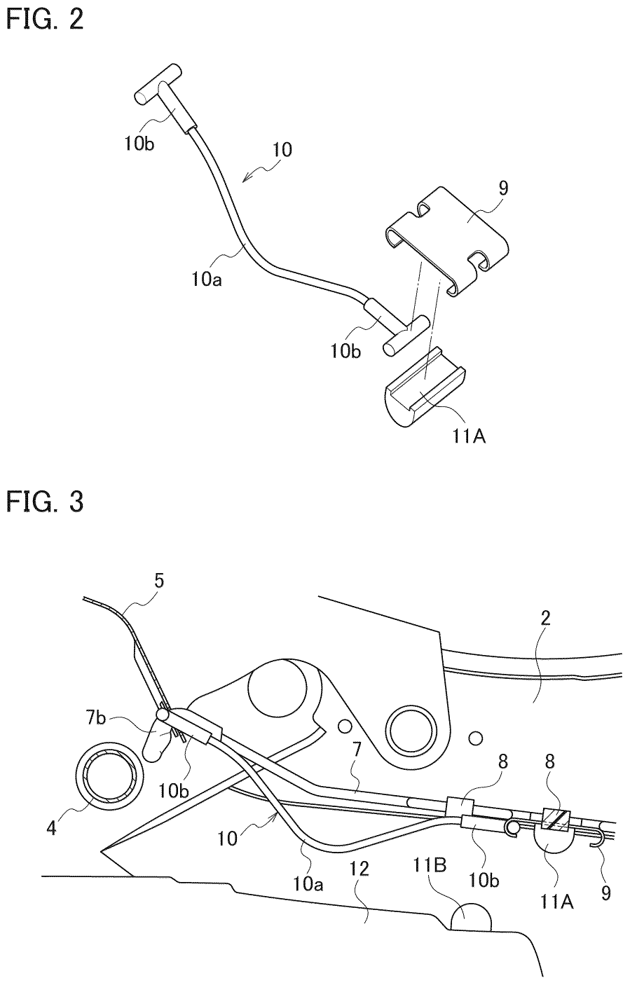

Each of the tensible wire 10 in the present embodiment is configured by fixing its attachment hook 10b to each end of its intermediate wire 10a by caulking, as shown in FIG. 2. The attachment hook 10b is a T-shaped hook. The head of the T-shaped hook is formed cylindrical. One end of the tensible wire 10 (one of the attachment hooks 10b) is loosely attached to a circular attachment hole formed on the rear member 3 or the front pan 5. The head of the T-shaped hook prevents the attachment hook 10b from being dislodged from the attachment hole. Since the attachment hook 10b is loosely attached to the attachment position (the attachment hole) of the cross member, such as the rear member 3 or the front pan 5, one end of the tensible wire 10 can swing perpendicularly to the cross member.

The other end of the tensible wire 10 (the other of the attachment hooks 10b) is attached to the two-pronged and curled end of the holder 9. The cylindrical head of the T-shaped hook is rotatable within the curled end of the holder 9. Therefore, at the attachment position (the holder 9) where the other end of the tensible wire 10 (the other of the attachment hooks 10b) is attached to the retention member 8, the other end of the tensible wire 10 (the other of the attachment hooks 10b) can also swing perpendicularly to the retention member 8 (the holder 9).

The tensible wire 10 is made strained and then tensioned when the S-springs 7 are subjected to the above-mentioned excessive vertical load. Until the tensible wire 10 is made strained, no tensile force applies to the tensible wire 10. That is, the tensible wire 10 is a surplus length wire that has a length longer than the distance between the attachment position of its one end to the retention member 8 (i.e., the holder 9) and the attachment position of its other end to the one of the cross members (the rear member 3 or the front pan 5) (i.e., the attachment hole).

The tensible wire 10 (the surplus length wire) of the present embodiment is a flexible wire that is easily curved due to its own weight or the like, more specifically, it is a twisted metal wire. That is, the intermediate wire 10a is made of a twisted metal wire. Note that it is also possible to use a solid wire such as a piano wire as the intermediate wire 10a for the surplus length wire. In this case, with no downward load acting on the S-springs 7, the solid wire is not made straight but made flexural. Thus, the solid wire, which is not a flexible wire, can function as the surplus length wire. A wire configured by joining many elements, such as a chain, can also function as a flexible wire. That is, a chain is not a twisted metal wire, but can function as a flexible wire.

The vehicle of the present embodiment is an electrified vehicle as described above, and a battery pack 12 is installed below the bottom frame 1 as shown in FIG. 3. Plural battery modules containing battery cells and battery control devices are accommodated inside the battery pack 12. Since the battery pack 12 is heavy, it is generally placed near a floor of a passenger compartment in order to lower the vehicle's center of gravity. In addition, if an installed volume of the battery pack is increased in order to get a sufficient driving range, the height of the battery pack 12 reaches higher than the height of the floor panel of a foot space for an occupant.

In such a case, there is concern about a contact between the S-springs 7 and the battery pack 12 when the above-mentioned excessive vertical load acts on the S-springs 7. If such a contact is repeated, there is also concern that the battery pack 12 may be damaged. Other types of device units, instead of the battery pack 12, may be installed below the bottom frame 1 and it reaches higher than the floor panel of a foot space. A car audio amplifier and an air conditioning blowout duct could be such device units. A fuel tank could be also such a device unit when the fuel tank is placed under a floor panel below a seat in order to utilize a space under the seat effectively. However, since the fuel tank is installed below the floor panel, a bulge is formed on the floor panel that protrudes upward from the floor panel of a foot space so as to associate with the fuel tank.

When a device unit such as the battery pack 12 is installed below the bottom frame 1, a clearance between the bottom frame 1 and the device unit becomes smaller. Therefore, if the vertical load is too large, there is concern that the S-springs 7 and the device unit may come into contact with each other even when the above-mentioned excessive downward displacement restriction mechanism is provided. Therefore, in the present embodiment, a bump rubber 11A is attached to a bottom face of the retention member 8 as shown in FIG. 3 in consideration of an occurrence of a contact between the S-springs 7 and the device unit.

The bump rubber 11A is attached to a position where the holder 9 is insert-molded into the retention member 8. Therefore, the bump rubber 11A is also attached to the holder 9 as shown in FIG. 2. In the present embodiment, the bump rubber 11A is attached to the retention member 8 and the holder 9 by adhesive. The bump rubber 11A has a semi-cylindrical shape and its curved surface is directed toward the device unit. In this way, even when the bump rubber 11A and the device unit come into contact, an impact of such contact can be mitigated.

The bottom frame 1 can slide on the seat rails 6 fixed to the floor panel as described above. Therefore, depending on the sliding position of the bottom frame 1, the bump rubber 11A may be located at a position where it does not contact the device unit. For this reason, a bump rubber 11B is also attached to a top face of the battery pack 12 as the device unit in the present embodiment. The bump rubber 11B has a semi-cylindrical (or hemispherical) shape similar to the above-mentioned bump rubber 11A, and is attached to the top face of battery pack 12 by adhesive. The bump rubber 11B on the top face of the battery pack 12 prevents contact between the battery pack 12 and the S-springs 7.

According to the seat frame for a vehicle in the above embodiment, the excessive downward displacement of the S-springs 7 can be restricted by the tensible wires 10 suspended between the retention members 8 and the cross members (the rear member 3 or the front pan 5). Therefore, the excessive downward displacement of the S-springs 7 caused by the excessive vertical load can be restricted even while improving the riding comfort when an occupant is seated by making the stiffness of the S-springs 7 lowered. As a result, the downward displacement of the seat surface does not become excessively large when an occupant kneel on one knee on the bottom unit to pick up a luggage on a seat on the other side as described above, and thus it does not become difficult to pick up the luggage.

Note that, even when the device unit as described above is not installed below the bottom frame 1, the clearance below the bottom frame 1 may be very small in sedans and sporty cars. In such cases, contacts between the S-springs 7 and the floor panel are still a concern. If such contacts are repeated, there is concern about damages to the floor panel and damages to the S-springs 7. According to the seat frame for a vehicle in the above embodiment, the contacts between the floor panel and the S-springs 7 can be restricted even when the device unit such as the battery pack 12 is not installed but the clearance is small.

According to the seat frame in the above embodiment, each of the tensible wires is an surplus length wire that has a length longer than the distance between the attachment position of its one end to the retention member 8 and the attachment position of its other end to one of the cross members (the rear member 3 or the front pan 5). When there is no vertical load acting on the bottom frame 1, the surplus length wire flexes or droops down and thus no tension acts on the surplus length wire substantially. The tension acts on the surplus length wire only when the downward displacement of the S-springs 7 is excessive. Therefore, both improvement of the ride comfort and control of the excessive downward displacement can be achieved appropriately.

In the above embodiment, specifically, the surplus length wire (the tensible wire 10) is a flexible wire. The flexible wire, which is easily curved due to its own weight or the like, droops down when no tension acts thereon, and thus no stress or the like acts on the attachment portions at its both ends. In addition, attaching work of the flexible wires as the tensible wires 10 can be done easily when assembling the bottom frame 1.

In the above embodiment, more specifically, the flexible wire (the tensible wire 10, the surplus length wire) is a twisted metal wire. The twisted metal wire as the flexible wire does not lose its function even if one of its many strands that constitute the twisted wire is broken. In addition, since the twisted metal wire is made by twisting many strands together, the twisted metal wire can receive an impact tension while mitigating the impact tension by its own micro-extension.

According to the seat frame in the above embodiment, the device unit (such as the battery pack 12) having a height higher than the height of the floor panel of a foot space for an occupant is installed below the bottom frame and the bump rubbers 11A are attached to the bottom faces of the retention members 8. Therefore, the S-springs 7 may contact with the device unit even when the tensible wires 10 restrict the above-mentioned excessive downward displacement. However, even when the S-springs 7 contact with the device unit, the bump rubbers 11A can prevent the device unit from being damaged.

According to the seat frame in the above embodiment, the tensible wire 10 is swingably attached at the attachment position (the holder 9) of the one end of the tensible wire 10 to the retention member 8. Similarly, the tensible wire 10 is swingably attached at the attachment position (the mounting hole) of the other end of the tensible wire 10 to one of the cross members (the rear member 3 or the front pan 5). Therefore, even when a tensile force acts on the tensible wire 10, which is flexing or drooping, and then is made strained, the ends of the tensible wire 10 can swing and thereby no stress concentration occurs at the attachment positions of the tensible wire 10. This prevents the tensible wires 10 (the intermediate wires 10a) from breaking.

The seat frame of the present invention is not limited to the seat frame in the above embodiment. As described above, the tensible wire (surplus length wire) 10 may be a non-flexible solid wire (a piano wire) or a non-flexible twisted metal wire that is attached in a flexural state between the retention member and the cross member. As described above, the ends of the tensible wire (surplus length wire, flexible wire, twisted metal wire) 10 may be attached directly to the retention member 8 without the holder 9.

Although the metal holder 9 is insert-molded into the plastic retention member 8 in the above embodiment, the metal holder 9 may be attached to a metal retention member by a rivet. Note that, as described above, the holder 9 may not be provided.

In the above embodiment, the tensible wires (surplus length wires, flexible wires, twisted metal wires) 10 are disposed between the two S-springs 7 on the right and left sides, respectively. However, an additional tensible wire (surplus length wire, flexible wire, twisted metal wire) 10 may be provided between the retention member 8 connecting the two adjacent S-springs 7 in the center and the cross member (the rear member 3 or the front pan 5).

A resin coating may be formed on the surface of the above-mentioned tensible wire (surplus length wire, flexible wire, twisted metal wire) 10. The resin coating prevents the generation of noise due to contact with peripheral parts or the inner edge of the attachment hole.

In addition, in the above embodiment, the tensible wire (surplus length wire, flexible wire, twisted metal wire) 10 is provided between the two retention members 8 (the holders 9) on the right (or left) side. The tensible wire (surplus length wire, flexible wire, twisted metal wire) 10 may be further provided between these two retention members 8 (the holders 9) as well.

Note that, in the above embodiment, the S-springs 7 are stretched between the rear member 3 and the front member 4 (i.e., between the two cross members) in the longitudinal direction, but they may be stretched between the pair of the side arms 2, i.e., in a lateral direction. In this case, each one end of the tensible wires (surplus length wires, flexible wires, twisted metal wires) 10 is attached to the retention member 8 and each other end is attached to any one of the two side arms 2.

Furthermore, the seat frame in the above embodiment is a seat frame for a single-person seat that can slide. However, the seat frame of the present invention can also be applied to a seat frame for a non-slidable multi-person seat such as a rear seat.

### REFERENCE SIGNS LIST

1 bottom frame
2 side arm
3 rear member (cross member)
4 front member (cross member)
5 front pan (cross member)
7 S-spring (serpentine spring)
8 retention member
10 tensible wire (surplus length wire, flexible wire, twisted metal wire)
11A bump rubber
12 battery pack (device unit)

1. A seat frame for a vehicle, the seat frame comprising:
a pair of side arms of a bottom frame that supports buttocks and thighs of an occupant from below;
a pair of cross members that connect front sections and rear sections of the side arms, respectively;
at least two S-springs that are stretched between the cross members or between the side arms;
a retention member that is attached to the S-springs between the S-springs;
a tensible wire that is suspended between the retention member and one of the cross members or between the retention member and one of the side arms.

2. The seat frame for a vehicle according to claim 1,
wherein the tensible wire is a surplus length wire that has a length longer than a distance between an attachment position of one end of the tensible wire to the retention member and an attachment position of another end of the tensible wire to the one of the cross members or the one of the side arms.

3. The seat frame for a vehicle according to claim 2,
wherein the surplus length wire is a flexible wire.

4. The seat frame for a vehicle according to claim 3,
wherein the flexible wire is a twisted metal wire.

5. The seat frame for a vehicle according to claim 1, further comprising
a device unit that is installed below the bottom frame and has a height higher than a height of a floor panel of a foot space for the occupant; and
a bump rubber that is attached to a bottom face of the retention member.

6. The seat frame for a vehicle according to claim 1,
wherein the tensible wire is swingably attached at an attachment position of one end of the tensible wire to the retention member, and
wherein the tensible wire is swingably attached at an attachment position of another end of the tensible wire to the one of the cross members or the one of the side arms.
